(19) United States
(12) Patent Application Publication
(10) Pub. No.: US 2011/0113356 A1
(43) Pub. Date: May 12, 2011

(54) Visual analysis module for investigation of specific physical processes

(76) Inventors: Georgy Samsonidze, El Cerrito, CA (US); Guram Samsonidze, Tbilisi (RU)

(21) Appl. No.: 12/590,660

(22) Filed: Nov. 12, 2009

(51) Int. Cl. G06F 3/048

(52) U.S. Cl. 715/763

(57) ABSTRACT

The Visual Analysis Module (VAM) is a graphical user interface that can be linked to any computational code for solving time-dependent multi-parameter problems. VAM has two modes that can be toggled between, an active mode and an inactive mode. VAM operating in the inactive mode accumulates the data being computed and visualizes them in real-time. Upon switching to the active mode, VAM can be used to analyze the accumulated data and change the parameters of the system being studied, while the execution of the computational code is paused. Once VAM is switched back to the inactive state, the calculation continues with a new set of system parameters. The analysis of the accumulated computational data guides the user through the process of modifying system parameters in order to reach the optimal solution of the problem. VAM has multiple diverse capabilities to perform such analysis. By using VAM, one can explore the phase space of system parameters without the need to run a large number of calculations in order to examine each set of parameters individually. Thus, the unknown solutions are classified into different groups according to their time evolution, and the optimal solution is found within the designated group. This method is similar to the analytical treatment, but can also be used to solve highly-nonlinear problems with multiple parameters for which no analytical solution have yet been discovered.

### CROSS-REFERENCE TO RELATED APPLICATIONS

N/A

### STATEMENT REGARDING FEDERALLY SPONSORED RESEARCH

N/A

### THE NAMES OF THE PARTIES TO A JOINT RESEARCH AGREEMENT

N/A

### INCORPORATION-BY-REFERENCE OF MATERIAL SUBMITTED ON A COMPACT DISC

CD ROM attached in two copies, each containing computer program source code files as follows:

| File Name | Date of Creation | Size in bytes |
|---|---|---|
| Dialog01.rc | Nov. 4, 2009 | 59,392 |
| Dialog02.rc | Nov. 4, 2009 | 61,440 |
| Modshell.f90 | Nov. 4, 2009 | 36,864 |
| Module00.f90 | Nov. 4, 2009 | 117,760 |
| Module01.f90 | Nov. 4, 2009 | 11,264 |
| Module02.f90 | Nov. 4, 2009 | 136,192 |
| Module03.f90 | Nov. 4, 2009 | 216,064 |
| Module04.f90 | Nov. 4, 2009 | 265,216 |
| Module05.f90 | Nov. 4, 2009 | 229,376 |
| Module06.f90 | Nov. 4, 2009 | 168,960 |
| Module07.f90 | Nov. 4, 2009 | 146,432 |
| Module08.f90 | Nov. 4, 2009 | 269,312 |
| Module09.f90 | Nov. 4, 2009 | 319,488 |
| Program1.f90 | Nov. 4, 2009 | 17,408 |
| resource.fd | Nov. 4, 2009 | 33,792 |
| resource.h | Nov. 4, 2009 | 33,792 |

### BACKGROUND OF THE INVENTION

(1) Field of the Invention

The field of this invention is for computer software providing a graphical user interface and multiple computational modes for the solution of complicated computation-intensive problems with continuous feedback to the user. This feedback can then be used to alter the parameters to narrow the focus on the problem being solved.

(2) Description of Related Art Including Information Disclosed Under 37 CFR 1.97 and 1.98

Publication of related article in “Physical Review”, Volume 58, Number 24, Dec. 15, 1998, entitled: “Formation and propagation of shock waves in the conduction channel of a field-effect-transistor structure”.

Publication of related article in “Journal of Applied Physics”, Volume 86, Number 4, Aug. 15, 1999, entitled: “Nonlinear response of two-dimensional electron plasmas in the conduction channels of field effect transistor structures”.

Publication of related article in the Journal of Applied Physics, 123707, 2006, entitled: “Terahertz plasma wave generation in ultrashort-channel field effect transistors: the essential role of carrier drift velocity saturation”.

### BRIEF SUMMARY OF THE INVENTION

The visual analysis module is capable of finding an optimal solution for a set of integro-partial differential equations. The real-time visualization of the solution being computed is necessary but not sufficient functionality of the visual analysis module. The feedback mechanism from the visual analysis module to the computational code enables the user to modify the system parameters during the calculation. By varying the system parameters one can change the phase trajectory of the system to allow it to reach a new steady state in the phase space. The visual analysis module contains a mathematical unit for the analysis of the intermediate computational data. The mathematical unit helps to understand how much one should vary the system parameters while exploring the phase space. The mathematical unit is subdivided into functionally distinct blocks. The computational code and the visual analysis module are designed to form a two-level system where one of the components is in an active mode and the other is in a passive mode. The visual analysis module in its active mode allows one to analyze the intermediate computational data and to change the system parameters if needed. The visual analysis module in its passive mode collects the intermediate computational data and visualizes the dynamics of the system being studied.

### BRIEF DESCRIPTION OF THE SEVERAL VIEWS OF THE DRAWING(S)

### Reference Numerals as Used in Drawings

10—Visual Analysis Module (“YAM”) is the invention herein described
20—computational code linked to the Visual Analysis Module 10
30—monitor that displays the computational data
40—hard disk that stores the computational data
50—dialog block which is comprised of the dialog window 800, the option window 840 and the choice window 870
100—mathematical block which is comprised of the block environment, the block surface, the block rewrite, the block error, the block console, and the block mouse
110—mathematical block output array parameters are the working arrays to generate child windows as passed from the mathematical block 100 to the input window 750
150—block shell transfers the intermediate computational data from computational code 20 to block distributor 300
200—block begin which opens the main window and initializes the global flags and working arrays
210—block begin parameters which are passed from block begin 200 to block input 250 to enable loading up working arrays and generating child windows 50
250—block input which sets the initial values of system parameters, the dimensions of working arrays and the list of child windows 50
260—block input parameters which are passed from block input 250 to block distributor 300 to enable loading up working arrays and layout of child windows 50
300—block distributor which modifies the global flags and accumulates the computational data sent from the external calculation program
310—block distributor working parameters are the parameters passed from block distributor 300 to the mathematical block 100 to enable loading up working arrays and layout of child windows 50
350—block input window allows to change the values of the system parameters and the dimensions of the computational arrays
360—input window output parameters which indicate if the button Dialog, Option, or Choice has been pressed in the input window 750
370—input window output parameters which indicate if the button Exit has been pressed in the input window 750
380—block input working parameters are working arrays and layout of child windows 50 that are read from the hard disk
400—block flip-flop input parameters which indicate a possible change of the working window in the mathematical block 100
410—block flip-flop output parameters which contain the global Flag Mode (“FM”) and activate the remind window 500
450—Flag Mode (“FM”) parameters which are passed to dialog block 50 to activate the dialog window 800, the option window 840, or the choice window 870
500—block remind window displays a popup window asking to confirm the change of the mode of operation
510—remind window output parameters which are passed to block distributor 300 to activate one of the windows of dialog block 50 in the active mode
520—remind window output parameters which indicate if the button Exit has been pressed in the dialog window 800 in dialog block 50
550—block parameters input parameters which contain the updated system parameters passed to the external computational program 20 from mathematical block 100 in the passive mode
600—Flag Show (“FS”) parameters which are passed to the external computational program 20 indicating whether the computational data are displayed in the passive mode
650—block rewrite working parameters are the working arrays and layout of child windows in dialog block 50 that are read from and written to the hard disk
700—block stop which terminates the Visual Analysis Module 10 processing
750—input window shows the initial values of the system parameters of the computational code 20 and the dimensions of the computational arrays
760—parameter box shows the system parameters passed to the computational code 20
770—control buttons switch the mode of operation of the Visual Analysis Module 10
780—dimension of working arrays sets the dimensions of the computational arrays
800—dialog window allows the user to configure a set of child windows, to change the information displayed in the child windows, and to write the computational data to the hard disk 40
805—control buttons switch the mode of operation of the Visual Analysis Module 10
810—block next mode selects the mode of operation upon pressing the control button OK 805
815—block previous/next cycles through the active child windows
820—block windows changes the status of the corresponding child window, switches between different child windows, opens and closes the child windows
825—block save on HD saves the parameters of the dialog window 800 and the computational data displayed in the child window on the hard disk 40
830—block in stack every N iteration sets the frequency at which the computational data are displayed in the child window
840—option window configures the corresponding child window
845—control buttons switch the mode of operation of the Visual Analysis Module 10
850—block change color changes the colors of the surfaces and markers and the background color of the child window
855—block show window cycles through the active child windows
860—block save on HD saves the parameters of the child window on the hard disk 40
870—choice window changes the system parameters
875—control buttons switch the mode of operation of the Visual Analysis Module 10
880—box integer (2) allows to set up to four system parameters of type integer on each of five tabs
885—box real (4) allows to set up to four system parameters of type real on each of five tabs
890—status box allows to set the status of the system parameters defined in the choice window 870
895—block save on 1111 saves the system parameters entered in the choice window 870 and their status to the hard disk 40
900—channel of the field effect transistor
905—source of the field effect transistor
910—drain of the field effect transistor
915—gate of the field effect transistor
920—gate insulator of thickness d in the field effect transistor
925—steady-state solutions area in the phase space
930—shock wave generation area in the phase space
935—chocking area in the phase space
950—child window density of electrons in the main window of VAM 10
955—child window velocity of electrons in the main window of VAM 10
960—control zero child window in the main window of VAM 10
965—remind window in the main window of VAM 10
970—menu of the main window of VAM 10

### BRIEF DESCRIPTION OF THE SEVERAL VIEWS OF THE DRAWINGS

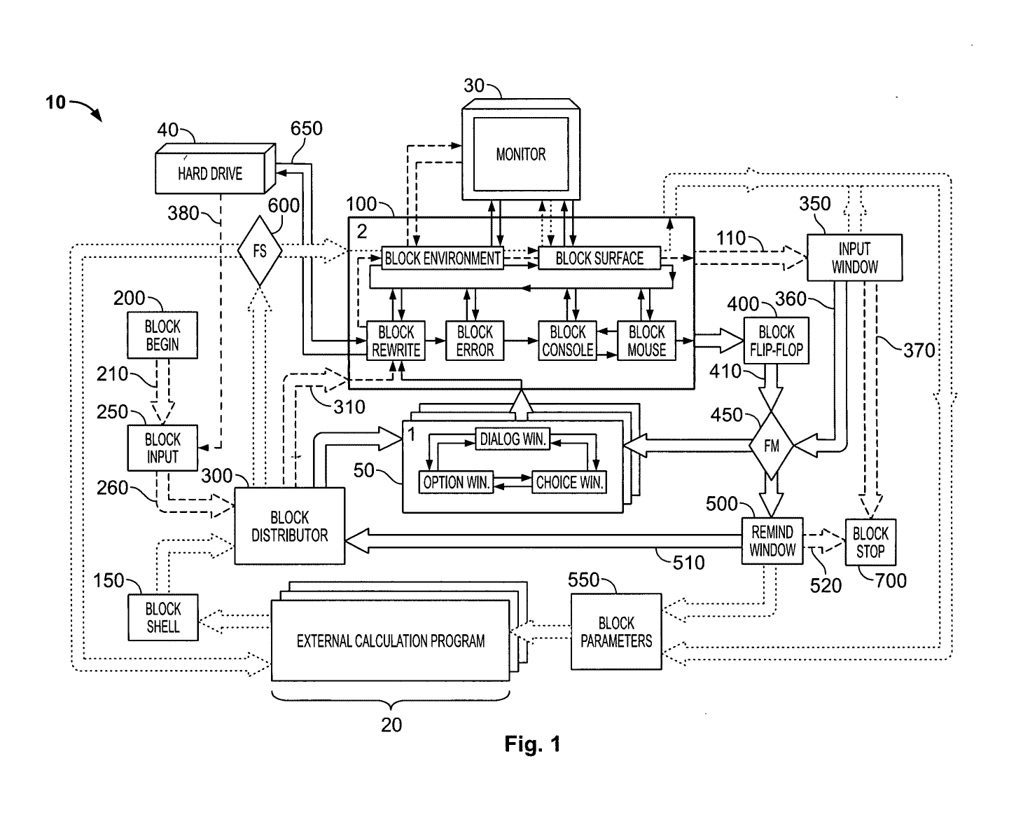

FIG. 1—a block diagram of the major components of the invention

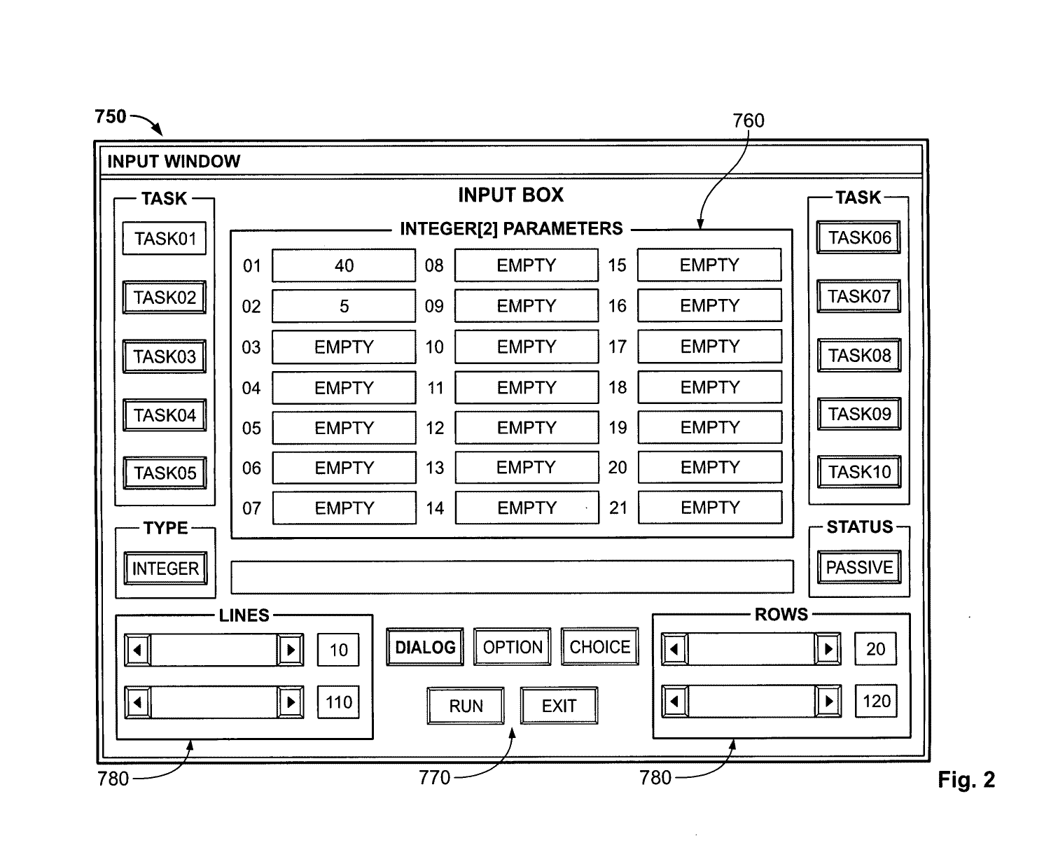

FIG. 2—a view of the human interface data entry window for entering parameters

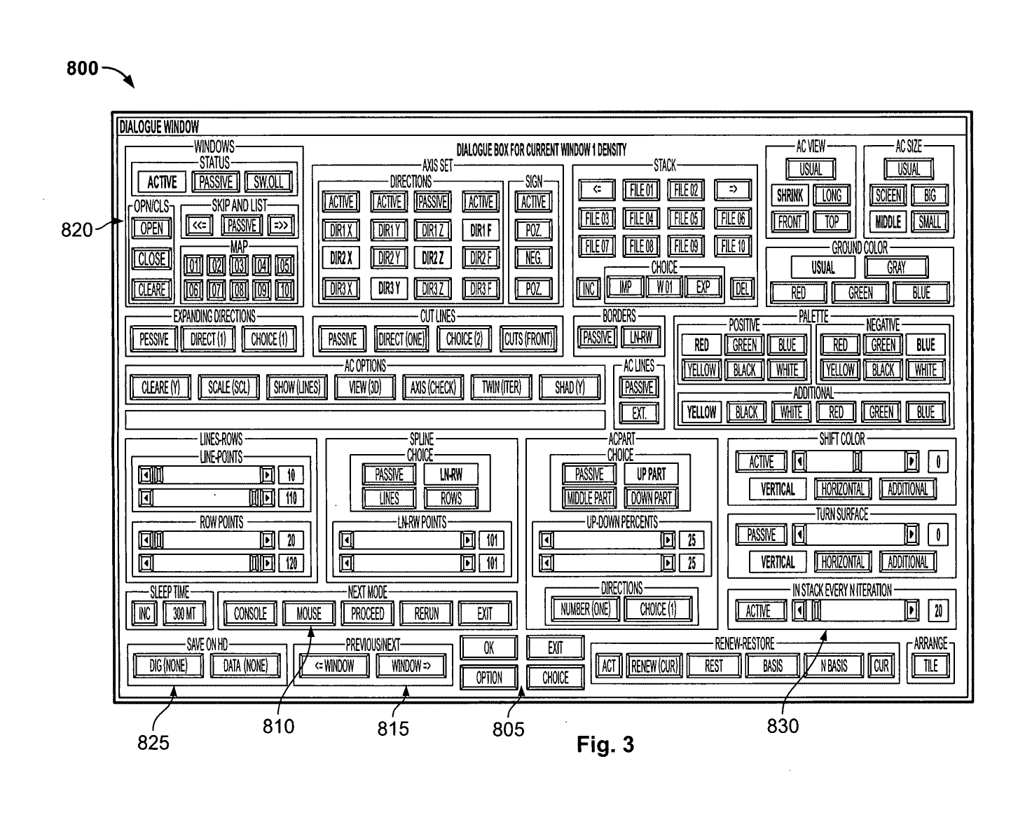

FIG. 3—a dialog window for human interface to allow the user to configure a set of child windows

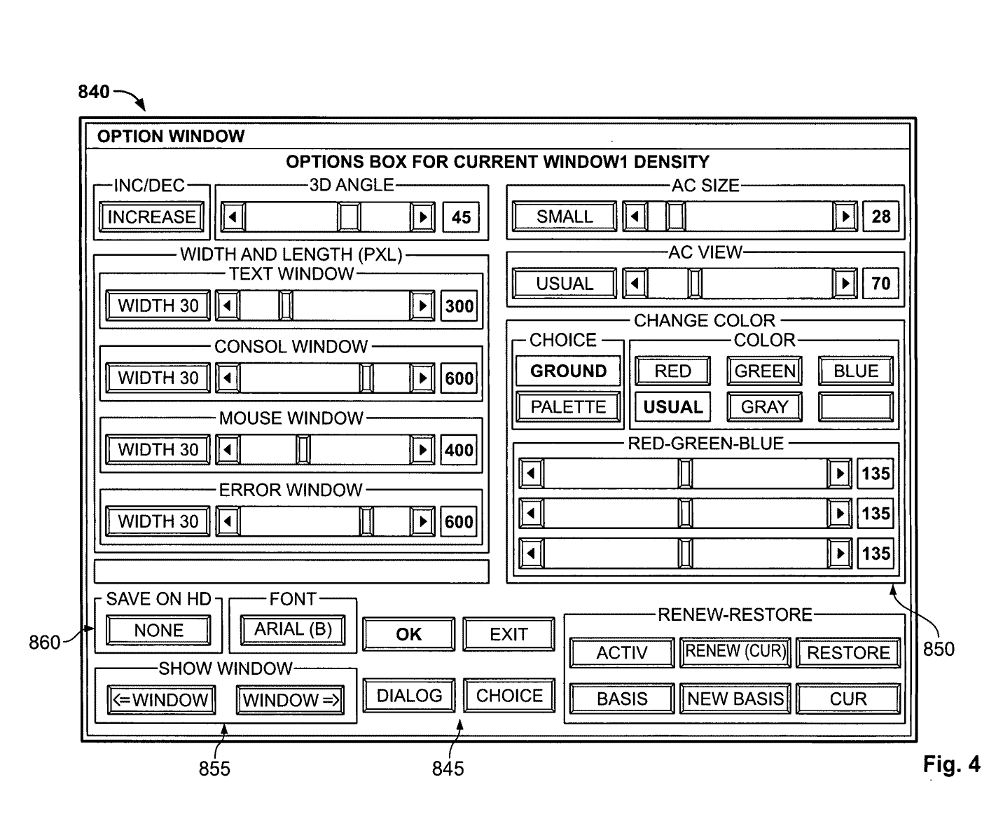

FIG. 4—a dialog window for human interface to set options for a child window

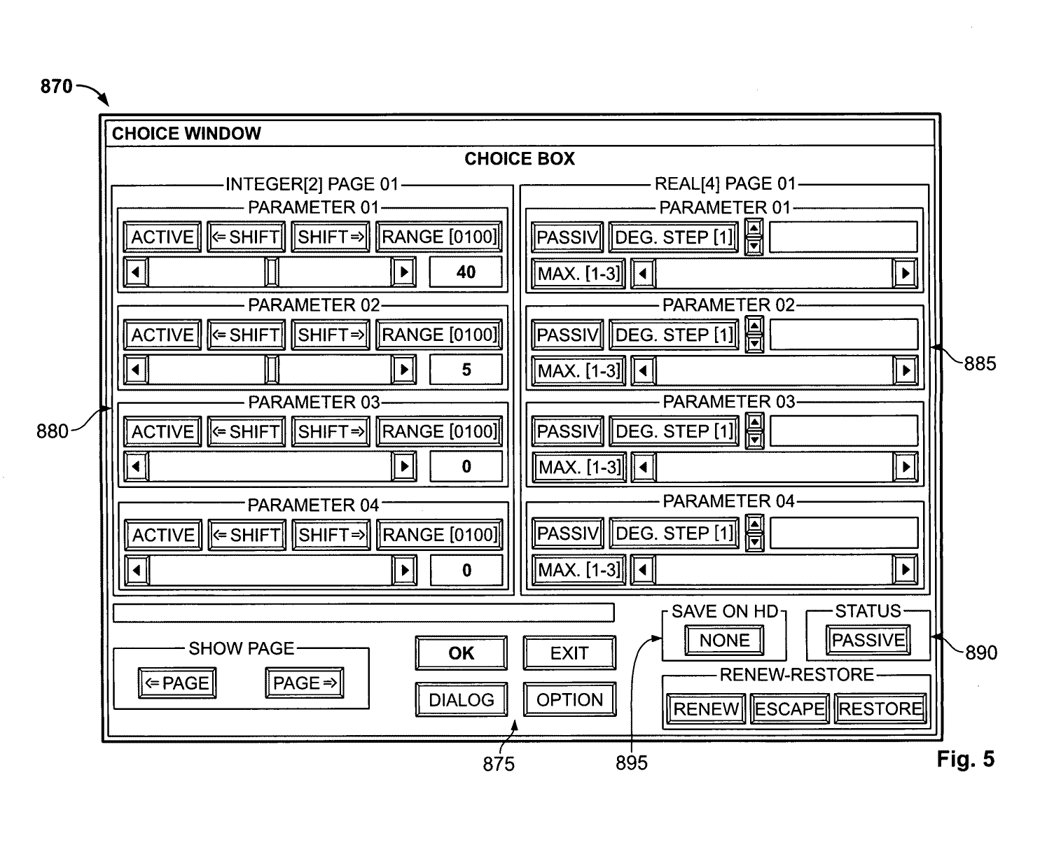

FIG. 5—a dialog window for human interface to allow choices of system parameters

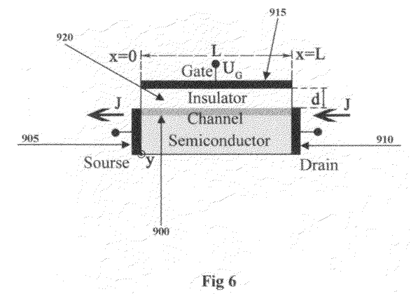

FIG. 6—shows a front view of the field effect transistor

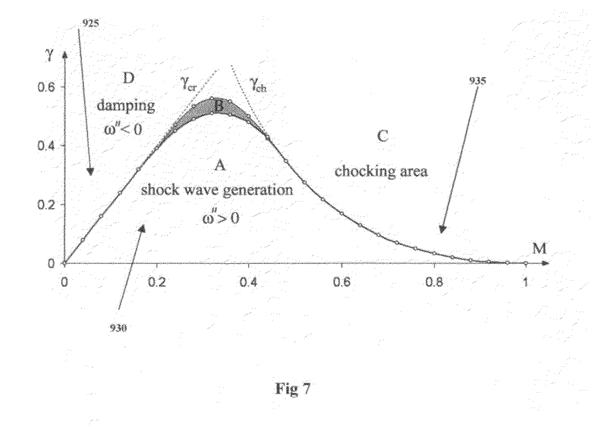

FIG. 7—Phase diagram of the plasma wave instability

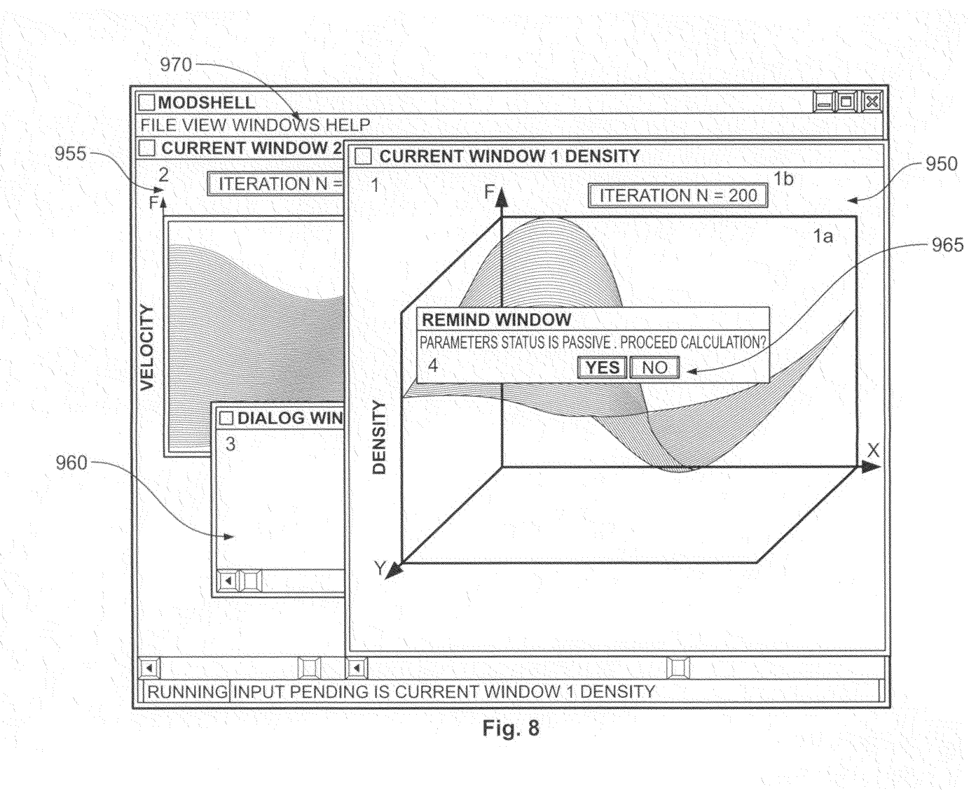

FIG. 8—depicts the main window of the Visual Analysis Module

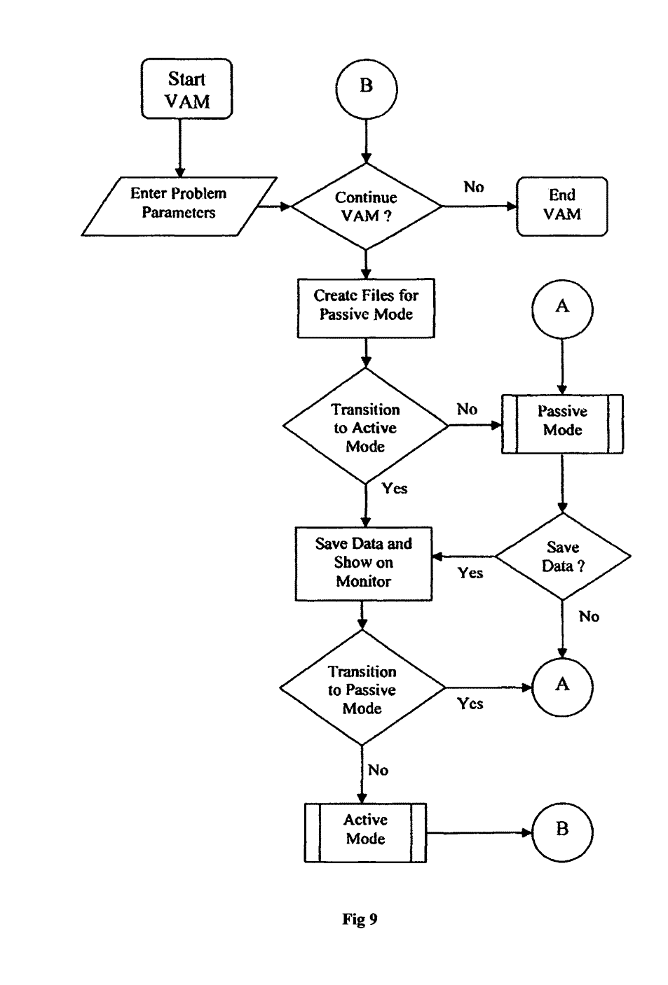

FIG. 9—high level flowchart for Visual Analysis Module control flow

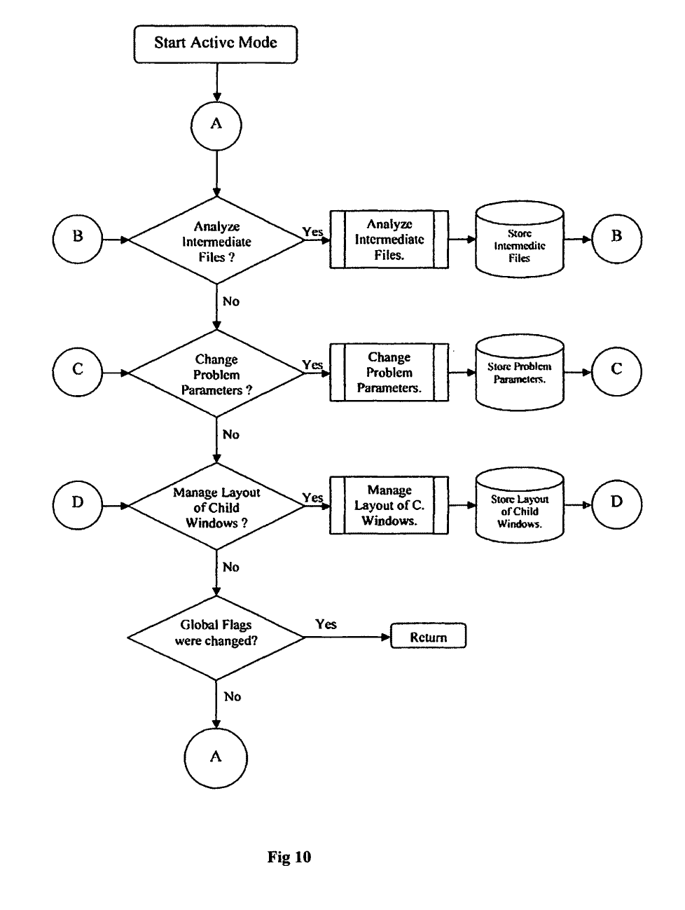

FIG. 10—high level flowchart for Visual Analysis Module Active Mode

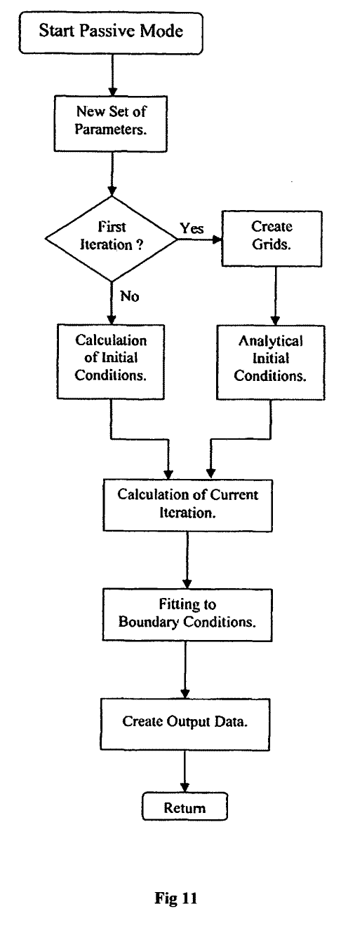

FIG. 11—high level flowchart for Visual Analysis Module Passive Mode

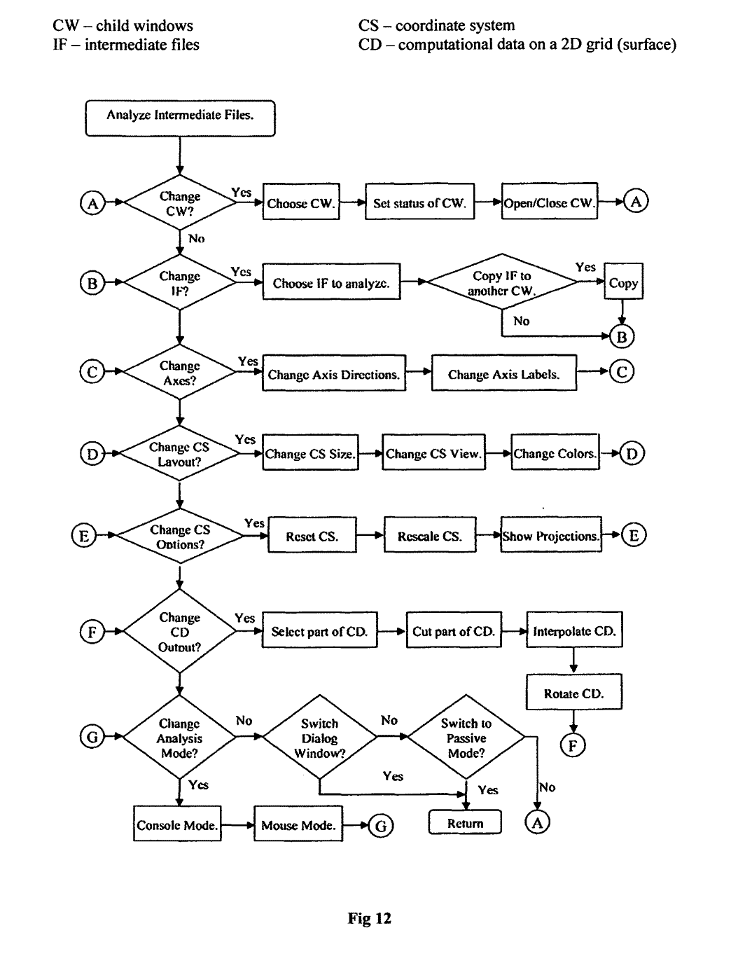

FIG. 12—flowchart for steps in analyzing intermediate files

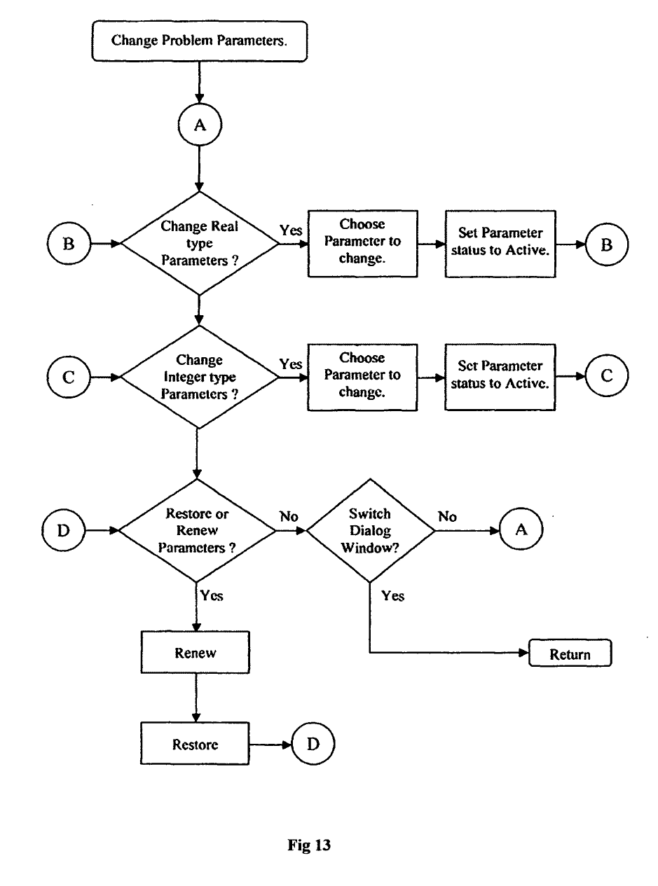

FIG. 13—flowchart for steps in changing problem parameters

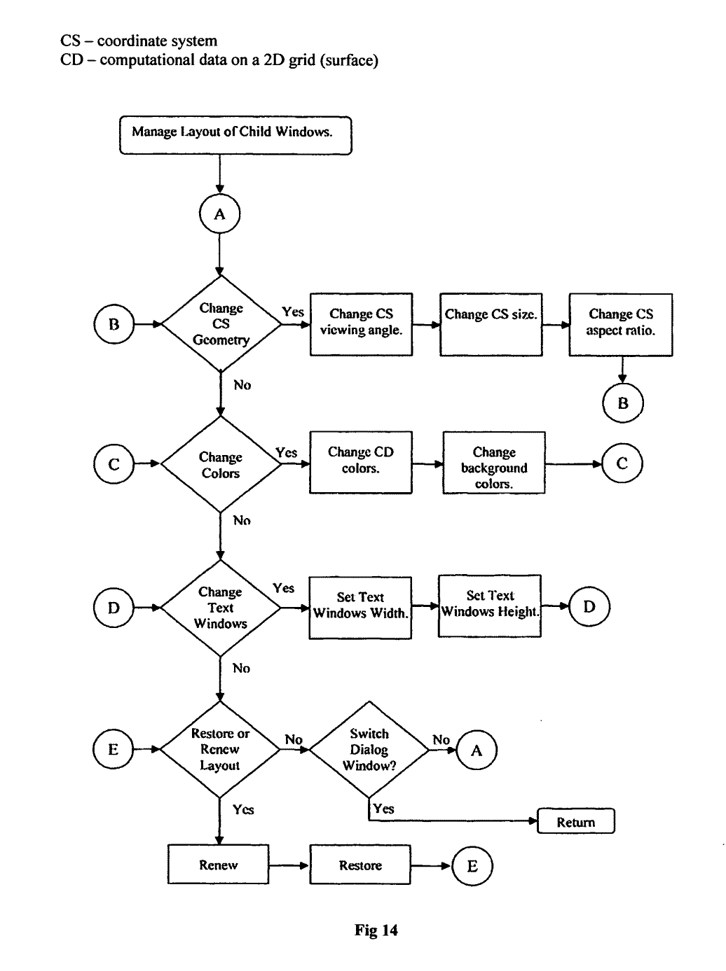

FIG. 14—flowchart for steps in managing the layout of the child windows

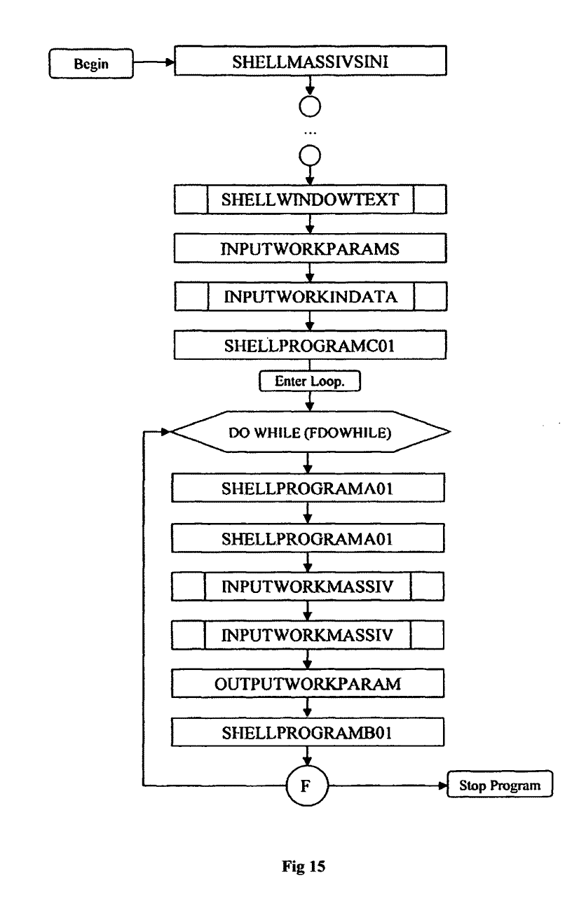

FIG. 15—control flow for the SHELLMASSIVSINI program

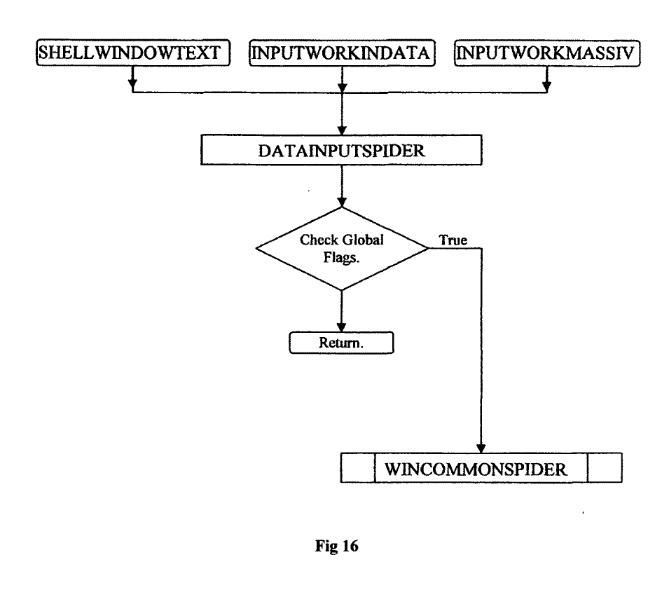

FIG. 16—control flow for invoking the WINCOMMONSPIDER program from DATAINPUTSPIDER program

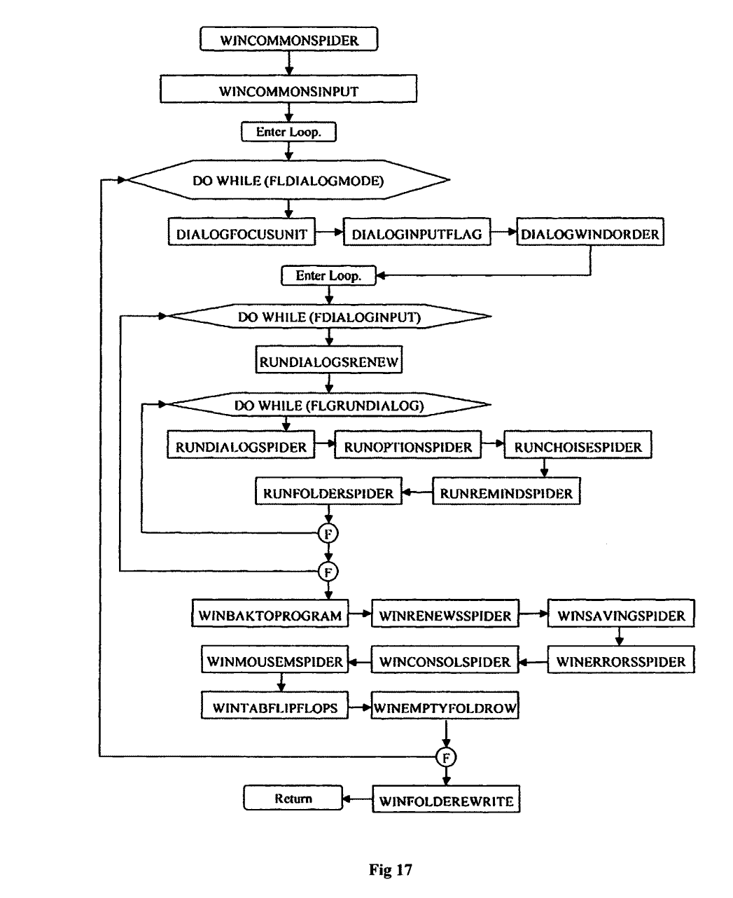

FIG. 17—control flow for the WINCOMMONSPIDER program

### DETAILED DESCRIPTION OF THE SEVERAL VIEWS OF THE DRAWINGS

FIG. 1—shows the block scheme of the Visual Analysis Module. The arrows show the sequence of activation of different blocks of VAM (sets of functionally similar subprograms of VAM) and the data transfer between the blocks of VAM and the computational program. The green arrows connect those blocks that initialize VAM by loading up working arrays and generating child windows. These child windows display the information passed from the computational program. The red arrows pass control to block Stop that terminates VAM. After VAM is initialized it can work in either active or inactive mode of operation. The orange arrows show the sequence of work of the computational program and the blocks of VAM when the latter is toggled to the passive mode of operation. The blue arrows connect the blocks that gain control when VAM is toggled to the active mode of operation. Toggling the mode of operation can be performed at any time during the data transfer between the computational program and VAM. Let us proceed to the detailed description of each block of VAM and toggling VAM between the two modes of operation.

FIG. 2—a view of the human interface data entry window for entering parameters Dialog window “Input Widow” shows the initial values of the parameters of the computational programs connected to VAM and the dimensions of the computational arrays passed to VAM.

Block “Task” selects the working program from the set of computational programs connected to VAM.

Block “Parameters” shows the system parameters passed to the working program.

Button “Type” selects the type of system parameters shown in block “Parameters”, either Integer or Real.

Block “Lines” and block “Rows” define the dimensions of the computational arrays.

Button “Status” selects the status of blocks “Lines” and “Rows”. If option “Active” is selected the new dimensions of the computational arrays are passed to VAM.

Control button “Dialog” switches VAM to the active mode of operation. This button launches the “Dialog” window.

Control button “Option” switches VAM to the active mode of operation. This button launches the “Option” window.

Control button “Choice” switches VAM to the active mode of operation. This button launches the “Choice” window.

Control button “Run” switches VAM to the passive mode of operation.

Control button “Exit” terminates VAM.

FIG. 3—a dialog window for human interface to allow the user to configure a set of child windows of VAM, to change the information displayed in their central area, to change the mode of operation of VAM, to write the arrays of working and computational data to HD, to set the frequency at which the computational data to stack.

Block “Windows Status” changes the status of the child window (Active, Passive, Switch off).

Active—stores the computational arrays in VAM and displays them in the child window. Passive—stores the computational arrays in VAM without displaying them in the child window. Switch off—does not store the computational arrays and does not display them in the child window.

Block “Windows Skip” switches between the active dialog and the child windows.

Block “Windows Open/Close” opens and closes the child windows of VAM. All the changes are performed upon pressing the “OK” button. This block does not close the active child window.

Block “Directions” sets the correspondence between the coordinate axes in the child window and the elements of the computational arrays. “Dir. 1” represents the x-coordinate or abscissa, “Dir. 2” the y-coordinate or ordinate, and “Dir. 3” the z-coordinate.

Block “Directions Signature” reverses the sign of the coordinate axis.

Block “Stack” has nine tabs. The left and right arrows switch between the tabs. Each tab contains 10 buttons. The buttons labeled from “File 01” to “File 90” represent the computational arrays. To erase one of the arrays, select the corresponding “File” button and press the “Del” button.

Block “Stack Choice” contains three buttons, “Imp,” “W,” and “Exp.” The “Imp” button imports the computational array from the child window to the selected “File.” The “Exp” button exports the computational array from the selected “File” to the child window. The child window is chosen by the “W” button.

Block “AC View” changes the orientation of the coordinate system in the child window.

Block “AC Size” changes the size of the coordinate system in the child window.

Block “Ground Color” changes the background color of the child window.

Block “Expanding Directions” rescales the coordinate axes.

Block “Cut Lines” identifies the lines crossing the coordinate system bounding box and draws the boundaries of the topologically disconnected parts of the surfaces displaying the computational arrays.

Block “Borders” allows to select the fragments of the computational surfaces to be displayed.

Block “AC Lines” draws the grid lines at the surface of the coordinate system bounding box.

Block “Palette” changes the colors of the displayed surfaces, grid lines and markers.

Block “AC Options” contains several switches. “Clear”—erases the computational data displayed in the child window after each iteration before plotting the new data. “Scale”—controls the scaling of the coordinate axes (“Scroll”—the scale is reset after each iteration, “Ground” and “Static”—the scale does not change). “Show”—the surface is displayed either as a grid (“Ln” and “Rw”) or as a set of lines (“Lines” or “Rows”). “View”—displays the three-dimensional surface (“3D”), its three projections (“Split”), or the front, top, and side view (“Front,” “Top,” “Back”). “Axis”—displays the coordinate axes. “Text Window”—displays the text header.

Block “Lines Rows” sets the indices “Line” (nₗmₗ) and “Row” (nᵣmᵣ) of the section of the computational data to be displayed. This approach does not introduce the lines crossing the coordinate system bounding box. The size of the section is given by the product (mₗ−nₗ+1)(mᵣ−nᵣ+1), and cannot be less than two.

Block “Spline” performs interpolation of the displayed section of the computational data. The interpolation is performed on the grid (“Ln” and “Rw”) or along the lines (“Lines” or “Rows”). The number of interpolated points is set within the “Spline” block.

Block “AC Part” displays the section of the computational data bounded by surfaces normal to the coordinate axes. The section is selected in the “Choice” block. The bounding surfaces are chosen in the “Directions” block.

Block “Shift Color” shifts the boundary between two colors of the displayed surface along one of the coordinate axes.

Block “Turn Surface” rotates the displayed surface along one of the coordinate axes.

Block “In Stack Every N Iterations” sets the number of iterations after which the computational data are stored in the Visual Analysis Module and displayed in its child windows.

Block “Sleep Time” sets the time delay between displaying two consecutive sets of computational data in the active child window.

Block “Next Mode” selects the mode of the two-level system activated upon pressing the “OK” button.

Block “Previous/Next” switches between the active “Dialog” windows. The “Dialog” window is activated upon opening the corresponding child window.

Block “Save on HD” saves on the disk the parameters of the “Dialog” window (the “Dlg” button) and the surface displayed in the child window (the “Data” button).

Block “Renew Restore” allows to save the current options or to restore the previous or default options for the active child window or for all the child windows.

Block “Arrange” arranges the child windows.

Control button “OK” saves changes made in the “Dialog” window. The mode selected in the “Next Mode” block is activated.

Control button “Exit” cancels changes made in the “Dialog” window and activates the “Console” mode.

Control button “Option” launches the “Option” window.

Control button “Choice” launches the “Choice” window.

FIG. 4—a dialog window for human interface to set options for a corresponding child window Block “3D Angle” changes the angle between the x-axis or abscissa and the z-axis.

Block “Width and Length” sets the width and height of the information windows.

Block “AC View” rescales the first three options of the “AC View” block of the “Dialog” window.

Block “AC Size” rescales all the five options of the “AC Size” block of the “Dialog” window.

Block “Change Color” changes the colors of the displayed surfaces and markers (the “Palette” button) and the background color (the “Ground” button).

Block “Renew Restore” is identical to the “Renew Restore” block of the “Dialog” window.

Block “Show Window” is identical to the “Show Window” block of the “Dialog” window.

Block “Font” changes the font used in the child window.

Block “Save on HD” saves on the disk the parameters of the child window.

Button “Inc/Dec” is an auxiliary button that changes the sequence of displaying the activated options on the buttons of “Option Window”.

Control button “OK” saves changes made in the “Option” window and activates the “Console” or “Mouse” mode.

Control button “Exit” cancels changes made in the “Option” window and activates the “Console” or “Mouse” mode.

Control button “Dialog” launches the “Dialog” window.

Control button “Choice” launches the “Choice” window.

FIG. 5—a dialog window for human interface to allow choices of system parameters (described from left to right, from top to bottom).

Block “Integer” allows to set up to four system parameters of type integer on each of five tabs.

Block “Real” allows to set up to four system parameters of type real on each of five tabs.

Block “Status” sets the status of the system parameters to “Active” or “Passive.” If the status is set to “Active,” the new values of the system parameters are passed from the visual analysis module to the computational program. If the status is set to “Passive,” the values of the system parameters set in the visual analysis module are ignored.

Block “Save on HD” saves on the disk all the system parameters, their status and the index of the computational program to which these parameters are passed from the Visual Analysis Module.

Block “Renew Restore” allows to save the current or to restore the previous system parameters.

Block “Show Page” switches between the five tabs of the “Choice” window.

Control button “OK” saves changes made in the “Choice” window and activates the “Console” or “Mouse” mode.

Control button “Exit” cancels changes made in the “Choice” window and activates the “Console” or “Mouse” mode.

Control button “Dialog” launches the “Dialog” window.

Control button “Option” launches the “Option” window.

FIG. 6—shows a front view of the field effect transistor where the gate electrode is separated from the channel by the insulator film. The FET operates in two different regimes. At the gate bias (U_{G}) smaller than the FET threshold voltage (U_{T}) the source and drain contacts are separated by a potential barrier and the current between them is very low. An increase in the gate bias decreases the potential barrier height, resulting in an exponential increase in source-drain current. Above the threshold (U_{G}>U_{T}), electrons in the semiconductor are attracted to the gate creating a narrow channel of length L at the interface between semiconductor and gate insulator that connects the source and drain. The channel and the gate form the two plates of a capacitor separated by the gate insulator.

FIG. 7—Phase diagram of the plasma wave instability showing Asymptotes (dotted lines): 1—equation (12), 2—equation (15). The open dots show the results obtained by numerical solution of equations (5)-(7) in the absence of viscosity (κ=0). The actual phase lines have been calculated using the visual analysis module to explore the system of equations. The actual phase lines are shown by the red and blue curves in FIG. 7. The red curve restricts area A of shock wave generation. The gray area B confined by the red and blue curves is a transition area where the shock waves are being created and damped. This means that in area B, the time of shock wave generation tₛ is less than the damping time t_{d}≈1/ω″. Along the blue curve, the condition t_{d}≈tₛ is satisfied. In the chocking area C, no physical solution of equations (5)-(7) exist. In the damping area D, the electron plasma oscillations decay and the system stays in a stationary state.

FIG. 8—depicts the main window of the Visual Analysis Module (1)—First child window for density n(xᵢ, yⱼ, tₖ), (1a)—active area of the first child window, (1b)—information window of the first child window, (2)—Second child window for velocity v(xᵢ, yⱼ, tₖ), (3)—control child window (zero window), (4)—dialog window “Remind Window”.

FIG. 9 high level flowchart for Visual Analysis Module control flow for Main chart:
(1) Data input (parameters of the problem and dimensions of computational arrays). Possible transition to (5).
(2) Condition for the transition of VAM into the active or passive mode.
(3) Active mode of VAM. The change of the working mode of VAM. Transition to (4) or (5).
(4) Passive mode of VAM. The change of the working mode of VAM. Transition to (3) or (5).
(5) Final result.

FIG. 10 Active mode chart:
(1) Analysis of intermediate computational data. Store computational data on disk.
(2) Change parameters of the problem. Store the new parameters on disk.
(3) Manage the layout of the child windows of VAM. Store the new layout on disk.

(4) Transition between (1), (2), and (3).
(5) The change of the working mode of VAM into the passive mode.

FIG. 11 Passive mode chart:
(1) Pass the new parameters of the problem from VAM to the computational code.
(2) Pass the new computational arrays from the computational code to VAM.
(3) Visualization of intermediate computational data.
(4) The change of the working mode of VAM into the active mode.

FIG. 12—flowchart for steps in analyzing intermediate files
(1) Choose one of the child windows and set its status to active.
(2) Load up the computational data from the intermediate file to the active child window.
(3) Set the orientation of the coordinate axes and select the axis labels.
(4) Set the coordinate system size, view, and colors.
(5) Change the coordinate system orientation and select different projections to be displayed.
(6) Select a part of the computational data for analysis and interpolate it onto a regular grid.
(7) Perform qualitative analysis of the computational data (zoom in, shift, rotate, and plot projections) in the Console mode.
(8) Perform quantitative analysis of the computational data (display numerical value at each grid point) in the Mouse mode.
(9) Return to the active or passive mode of VAM.

FIG. 13—flowchart for steps in changing problem parameters
(1) Enter new values of real type problem parameters and set their status to active.
(2) Enter new values of integer type problem parameters and set their status to active.
(3) Save the current values of problem parameters to disk or restore the previous values of problem parameters from disk.
(4) Switch to Dialog Window and return to the active mode of VAM.

FIG. 14—flowchart for steps in managing the layout of the child windows
(1) Set the size and orientation of the coordinate system displayed in the content area of the child window.
(2) Change the colors of the coordinate system displayed in the content area of the child window.
(3) Set the parameters of the text boxes that appear in the child window.
(4) Save the current layout of the child window to disk or load the previously saved layout from disk.
(5) Switch to Dialog Window and return to the active mode of VAM.

FIG. 15—control flow for the SHELLMASSIVSINI program
1. SHELLMASSIVSINI The first procedure to load data from hard disk to Shell
2. SHELLWINDOWTEXT The last procedure to load data from hard disk to Shell
3. INPUTWORKPARAMS Passes the initial values of the system parameters from Shell to VAM
4. INPUTWORKINDATA Passes the array dimensions and number of child windows from Shell to VAM
5. SHELLPROGRAMA01 Passes the arrays of computational data from the computational code to Shell
6. SHELLPROGRAMB01 Passes the modified system parameters from Shell to the computational code
7. SHELLPROGRAMC01 Passes the array dimensions and the initial parameters from Shell to the code
8. INPUTWORKMASSIV Passes the arrays of computational data from Shell to VAM
9. OUTPUTWORICPARAM Passes the modified system parameters from VAM to Shell

FIG. 16—control flow for invoking the WINCOMMONSPIDER program from SHELLMASSIVSINI program
1. SHELLWINDOWTEXT loads data from hard disk to Shell.
2. INPUTWORKINDATA passes the array dimensions and number of child windows from Shell to VAM.
3. INPUTWORKMASSIV passes the arrays of computational data from Shell to VAM.
4. DATAINPUTSPIDER is a wrapper that loads data to VAM and provides visualization of computational data in the child windows of VAM in its passive mode.
5. Check Global Flags passes control to WINCOMMONSPIDER or SHELLMASSIVSINI depending on flags set in VAM in its active mode.
6. WINCOMMONSPIDER is a wrapper that runs the main procedures of VAM in its active mode.

FIG. 17 depicts the control flow for the WINCOMMONSPIDER program, the main procedures for the VAM, listed here in sequence steps
1. DATAINPUTSPIDER Wrapper that loads data to VAM and provides visualization of computational data in the child windows of VAM in the passive mode
2. WINCOMMONSPIDER Wrapper that runs the main procedures of the active mode
3. WINCOMMONSINPUT Checks if the zero child window is focused by mouse click. If yes, it sets the global flags for active or passive mode
4. DIALOGFOCUSUNIT Identifies the current child window in the active mode.
5. DIALOGINPUTFLAG Sets the global flags that control the operation of VAM in dialog mode
6. DIALOGWINDORDER Determines the order of the child windows of VAM.
7. RUNDIALOGSRENEW Prepares folders, or temporary files that contain the data displayed in the dialog windows of VAM and the current values of the system parameters to work in dialog mode
8. RUNDIALOGSPIDER Wrapper that activates VAM Dialog window
9. RUNOPTIONSPIDER Wrapper that activates VAM Option window.
10. RUNCHOISESPIDER Wrapper that activates VAM Choice window
11. RUNREMINDSPIDER Wrapper that activates VAM Remind window.
12. RUNFOLDERSPIDER Wrapper that stores the parameters modified in dialog mode
13. WINBAKTOPROGRAM Identifies the global flags when changing the mode of operation of VAM, for example when switching to the Mouse or Console Mode.
14. WINRENEWSSPIDER Wrapper that rewrites the VAM folders
15. WINSAVINGSPIDER Wrapper that writes data to hard disk.
16. WIN ERRORS SPIDER Wrapper that checks the content of VAM folders entered by the user in dialog mode and resolves possible conflicts
17. WINCONSOLSPIDER Wrapper for VAM in the Console Mode
18. WINMOUSEMSPIDER Wrapper for VAM in the Mouse Mode.
19. WINTABFLIPFLOPS Changes the current child window of VAM
20. WINEMPTYFOLDROW Erases the unused information in the VAM folders.
21. WINFOLDEREWRITE Writes the modified parameters to the VAM folders. When switching to the passive mode the parameters are loaded from the VAM folders to the computational code.

### DETAILED DESCRIPTION OF THE INVENTION

VAM (10) is a set of interconnected programs, which is easily connectable to a computational code (20). Together they form a program. This program allows one to investigate a specific physical process, in our example, the dynamics of electron plasma in a semiconductor chip. During the work of the program VAM (10) remains in passive or active mode. In the first case VAM (10) displays on the monitor (30) intermediate computational data and accumulates them in the memory. The data is sent from the computational code (20) to VAM. In the active mode VAM (10) allows the user to analyze the results of the calculation and then to modify the parameters of the problem being studied. The new parameters are passed into the computational code (20). It continues to calculate the problem with modified parameters. Such a structure lets us quickly find the optimal parameters for the design of the semiconductor chip.

The main purpose of connecting VAM (10) to the computational code (20) constitutes the ability to quickly determine the unknown solution to the problem being investigated. For example, during the design of a semiconductor chip from the many possible values of the chip parameters, the program chooses such values, for which the required physical process is realized. Modified boundary conditions blend the set of parameters into a technologically accessible region. When solving problems of the given class, it is necessary to know how this physical process evolves in space and time. This lets us understand, during the computational process itself, how and to what degree we need to alter parameters of the semiconductor chip, in order to obtain a set of optimal parameters, and thus the best design for the semiconductor chip.

VAM (10) does not produce computational data, and the computational code (20) does not analyze it. Together, VAM (10) and the computational code (20) form a convenient system for seeking the optimal solution. It is organized in such a way, that either VAM (10) or the computational code (20) is interchangeably switched to active or passive mode. Let us describe both of these modes in more detail:

When the computational code (20) is activated, VAM (10) automatically switches into passive mode, and vice versa. In the passive mode, VAM (10) accumulates intermediate computational data and can display them on the monitor (30) in the form of 2D or 3D graphics. In this mode, with the help of VAM (10), it is possible to observe the dynamics of electron plasma in the semiconductor chip. This is a qualitative analysis of the computational data. It does not allow changing of the chip parameters or its boundary conditions, and this analysis is not enough for searching the optimal parameters of the semiconductor chip. It is necessary at the preliminary stage of solving this kind of problems, since it allows identifying the range in which to modify the parameters of the semiconductor chip during the search for the optimal set of parameters.

Variation of the chip parameters and boundary conditions is possible when VAM (10) is switched into active mode. Then the computational code (20) switches into the passive mode waiting for a new set of parameters (550). The active mode of VAM (10) allows for investigation of the computational data stored in the memory, and for their comparison with each other. The quantitative and comparative analysis of the computational data allows determining how and to what degree to modify the chip parameters, in order to achieve the desired result.

The new set of parameters (550) is then passed to the computational code (20) and VAM (10) switches into passive mode. The calculation continues. In order for the program to be flexible and convenient, the mode change can be performed at an arbitrary moment of time (300). Analysis of the computational data in passive mode allows finding the range in which to modify the chip parameters. Identification of the set of optimal parameters of the semiconductor chip is possible in an active mode.

In our example of designing a semiconductor chip, let us identify the two parameters of the field-effect transistor semiconductor chip, namely Mach number and Friction (760), at which shock waves will be generated in its channel at terahertz frequency. The front of the shock waves must constitute no less than 90 percent of the change of electron density between source (905) and drain (910) in the transistor channel (900).

Let us start the program. The child windows of VAM (950, 955) and dialog window “Input Window” (750) will appear on the monitor (30). In the central block of this window (760), the initial values of the chip parameters: Mach number (0.1) and Friction (0.4) appear in the fields “Integer 01” and “Integer 02”, respectively. Press the control button “Run” (770). VAM (10) will switch into passive mode, and the computational code (20) into active. The program will start the calculation of the electron dynamics. VAM will accumulate the computational data in the memory.

The spatial distribution of density of electrons in the channel of field-effect transistor is displayed in the child window “Density” (950). Oscillations of electronic plasma in the channel decay with time. It is necessary to modify the parameters of the problem, since at these values of Mach number and Friction (760) the shock waves are not generated. For this we need to activate VAM (10). The left mouse click will bring up the child window “Dialog Window 0” (960). VAM (10) will switch into the active mode, and the computational code (20) into the passive mode. Computation is temporarily halted. The dialog window “Dialog Window” (800) appears on the monitor (30). In this window, press the control button “Choice” (805). The dialog window “Choice Window” (870) will appear on the monitor (30). Change the chip parameters in block “Integer (2)” (880) on the left side of the dialog window (870). Set Mach number to 0.05 and Friction to 0.4. In order for the new parameters to be passed to the computational code it is necessary to override their status (890).

By default the status of the parameters is set to passive. In the block “Status” (890) of the dialog window (870) change the option “Passive” to “Active”. Press the control button “Dialog” (875). The dialog window “Dialog Window” (800) once again appears on the monitor. At the bottom of this window in the block “Next Mode” (810) choose the option “Proceed”. Press the control button “OK” (805). The confirmation window “Remind Window” (500) appears on the monitor. Press the control button “Yes”. VAM (10) will switch into the passive mode, and the computational code (20) will be activated. The computation will continue with the new values of Mach number and Friction (760).

The initial conditions will be taken from the density and velocity distributions computed at the last iteration of the preceding calculation. With the new values of Mach number and Friction, oscillations of electronic plasma in the channel decay with time even faster. The new set of parameters was chosen incorrectly. Let us activate VAM (10) and change the parameters in the dialog window “Choice Window” (870). Set Mach number to 0.4 and Friction to 0.5 and resume the calculation. After several thousand iterations, a weak shock wave appears in the transistor channel.

Activate VAM (10) once again and reduce Friction in the dialog window “Choice Window” (870). The new set of parameters should be Mach number=0.4 and Friction=0.3. Choose the option “Proceed” in the dialog window “Dialog Window” (810). The shock waves in the transistor channel appear much faster and the wave-front slope is much steeper. This implies that Friction needs to be reduced. While altering Friction at constant Mach number, we find that the steepest shock waves are formed at Mach number=0.45 and Friction=0.05. Thus, using VAM (10), we have determined the optimal parameters of the chip.

### A Description of the Block Scheme as Used in VAM

When VAM (10) is started the two sets of setup subprograms, blocks Begin (200) and Input (250), are activated. The subprograms of block Begin (200) open the main window and initialize the global flags and working arrays of VAM (10). The global flags define the sequence of activation of the blocks of VAM (10). The working arrays are initialized to define the structure and palette of the child windows (950, 955) of VAM (10), the appearance, size and color of the plots displayed on the monitor, the frequency at which VAM (10) stores the data passed from the computational program (20), and other information required for visualization of the computational arrays and for their quantitative and comparative analysis.

The structure of the child windows (950, 955) of VAM (10) and the output of the computational data in these windows are independent of each other, because each child window is associated with its own set of working information. By default, VAM (10) opens one child window (950). If the current directory contains auxiliary files previously saved by VAM (10) the subprograms of block Input (250) read these files in. Thus, block Input (250) allows to set the initial values of the system parameters (760), the dimensions of the working arrays (780) passed from the computational program (20) to VAM (10), and the list of child windows (950, 955) opened up on VAM (10) startup. Besides, the subprograms of block Input (250) read in the working information for any of the child windows (950, 955) of VAM (10) from the hard disk (HD) (40). This allows to make any changes to the child windows (950, 955) of VAM (10) before starting the computational program (20).

The subprograms of block Rewrite (100) store the system parameters and working information read from HD (40) in the corresponding arrays of VAM (10). Block Distributor (300) plays the key role in VAM (10) operation. This set of subprograms modifies the global flags and stores the data periodically sent from the computational program (20) in stack. When VAM (10) is started block Distributor (300) initializes the storage arrays and activates mathematical blocks Rewrite (100) and Environment (100). The operation of block Rewrite (100) is described above. Block Environment (100) opens and arranges the child windows (950, 955) of VAM (10). Like in all blocks of mathematical unit, the local flags that define the sequence of work of the subprograms of block Environment (100) are set in this block. The values of these flags depend on the information in the working arrays of VAM (10). Dialog block Input Window (350) is the last block activated when VAM (10) is started.

The dialog blocks (50) allow changing the information in the working arrays of VAM (10). When one of the dialog blocks (50) is activated the corresponding dialog window (800, 840, 870) is displayed on the monitor. The window of dialog block Input Window (350) displays the values of the system parameters and the dimensions of the computational arrays (see FIG. 2). If this information is entered incorrectly, it can be changed in dialog window Input Window (750). At this point, the initialization part of VAM (10) is finished. VAM (10) can either be switched to one of its two modes of operation or closed by pushing one of the buttons (770) in dialog window Input Window (750). Buttons Dialog, Option and Choice (770) switch VAM (10) to the active mode of operation (the blue arrows (360, 410, 510) in FIG. 1). Button Run (770) switches VAM (10) to the passive mode of operation and passes control to the computational program (the orange arrows in FIG. 1). Button Exit (770) activates block Stop (700) (the red arrows in FIG. 1). Set of subprograms Input Window (250) partially duplicates the functionality of block Distributor (300). Namely, buttons Dialog, Option, Choice and Exit (770) reset the global flags of VAM (10). Let us describe the operation of VAM (10) and the computational program in both modes.

The set of subprograms Parameters (550) is activated in the passive mode of operation of VAM (10). The updated arrays of parameters are passed to the computational program (20) if the system parameters have been changed. The system parameters can also be changed in the active mode of operation of VAM (10) in dialog block Choice Window (50). Block Parameters (550) also passes the information about the calculation mode to the computational program (20). The calculation mode is selected in dialog window Dialog Window (50). There are four calculation modes: continuation or restart of the calculation with an old or a new set of system parameters.

If the passive mode of operation has been chosen in dialog window Input Window (750), the computational program (20) starts a new calculation with a new set of the system parameters. The computational arrays, the number of iteration, the time step, and the number of the child window that displays these arrays are passed from the computational program (20) to block Shell (150) on each step of the iteration in the main loop of the computational program (20). The information obtained from the computational program (20) is transferred to block Distributor (300). In the passive mode of operation of VAM (10), block Distributor (300) sorts the computational arrays, checks if the mode of operation has been reset, and modifies the global flags if YAM (10) has been toggled to the active mode of operation. If the number of iteration matches the frequency at which VAM (10) stores the data obtained from the computational program (20) and the child window (950, 955) that displays the computational arrays is not turned off, the information passed to block Distributor (300) is stored in stack.

The child windows (950, 955) of VAM (10) can be toggled between three states: active, passive and turned off. If the child window is active, the computational data is stored in stack and simultaneously displayed on the monitor. If the child window is passive, the computational data is stored in stack but not displayed on the monitor. The frequency at which VAM (10) stores the data obtained from the computational program and the state of the child window can be set in block Dialog Window (800) and saved in the working array of the window in the active mode of operation of VAM (10). Depending on the number of iteration and the state of the child window, the global flag Show (FS) (600) is set in block Distributor (300). The global flag Show (FS) (600) takes the value True only if the computational data are displayed in the VAM (10) window. In this case, the set of subprograms of the mathematical unit, block Surface (100), is activated. This set of subprograms converts the information passed to VAM (10) to a form suitable for visualization on the monitor (30). In the opposite case, the control is passed to the computational program (20) without displaying the computational data on the monitor. If the control zero child window (960) has been activated by the mouse click in the passive mode of operation of VAM (10), block Distributor (300) passes control to the dialog part (50) of VAM (10), and VAM (10) is switched to the active mode of operation. In contrast to the other child windows (950, 955), the control window (960) is not a working window in the sense that it does not display the computational data. The control window (960) is opened by default and it cannot be closed until VAM (10) is terminated.

VAM (10) is switched to the active state of operation by pressing button Dialog, Option or Choice (770) in dialog window Input Window (750). Switching VAM (10) from the passive to the active mode during the calculation is performed in block Distributor (300). This can be done by a mouse click on the control window (960) of VAM (10). In both cases all the global flags are reset. The flag Mode (FM) (450) takes the value True and the control is passed to one of the blocks of the dialog part of VAM (10): Dialog, Option, or Choice (50) (see the blue arrows in FIG. 1). The corresponding dialog window (800, 840, 870) is displayed on the monitor (see FIGS. 3 to 5). Each child window in VAM (10) has its own set of dialog windows (800, 840, 870). They are structurally identical but independent of each other. This is reflected on the block scheme: the dialog part (50) of VAM (10) is shown as a set of structurally identical tabs. The top tab corresponds to the working child window. The stored information is displayed on the screen in the mathematical part (100) of VAM (10). Changing options in the dialog window (800, 840, 870) can be global or local. In the first case the option is reset in all child windows (950, 955), in the second case only in the working child window (950 or 955). Each dialog window has buttons (805) that switch from one dialog block to another. The new dialog window (800, 840, 870) is then displayed on the monitor.

One can switch (805) between different dialog blocks within the same child window (the thin blue arrows on Tab 1 in FIG. 1) or between the same dialog blocks (815, 855) in different child windows. In the latter case the child window whose dialog block is activated becomes the working window. The number of tabs in the dialog part (50) of VAM (10) is equal to the number of opened child windows. The number of tabs and their states can be set in window Dialog (820). Using the options of this window the user can change the structure of the child window and modify the computational information displayed in its central (active) area. This dialog window (800) allows the user to change the mode of operation (810) of VAM (10), to write the current information (both working and computational) (825) to HD, to change the frequency (830) at which VAM (10) stores the data passed from the computational program (20), and to redefine the set of subprograms (810) of the mathematical unit (100) of VAM (10), Console (100) or Mouse (100) that will perform analysis of the computational information displayed in the child window. Changing the options of dialog window Option (840) allows modifying the shape and size of the active area of the child windows (950 or 955) of VAM (10). In dialog window Option (840), the user can set the background color and the colors of the computational surfaces displayed on the monitor (850).

The system parameters for the computational program (20) connected to VAM (10) can be modified in dialog window Choice (870). The functions and abilities of blocks Dialog, Option and Choice (50) are described below in more details (see FIGS. 3 to 5). The dialog part (50) of VAM (10) is terminated by pressing button OK or Exit (805, 845, 875) in any dialog window. Upon pressing button OK, the control is passed to block Rewrite of the mathematical part (100) of VAM (10). The set of subprograms Rewrite updates all the working arrays of the child windows (950, 955) of VAM (10) according to the options set in the dialog part (50) of VAM (10). Pressing button Exit cancels all the new settings. In this case, the local flags of blocks Rewrite and Error (100) take the value False and the control is passed to block Console or Mouse (100). Upon activation of mode Save (825, 860, 895), the new working arrays are written to auxiliary files in the current directory. Option Save of block Dialog (825) allows writing the computational information displayed in the working window of VAM (10) on HD (40). If it is needed to change the number of the child windows, to modify their active area, to change the background color or the colors of the plots displayed in these windows while the working arrays are updated, the control is temporarily passed to blocks Environment and Surface (100).

Environment (100) changes the number, shapes and colors of the child windows of VAM (10) according to the new working information. The set of subprograms Surface (100) converts the computational information to a form suitable for visualization on the monitor (30). If the new options of window Dialog (50) are contradictory, block Error (100) is activated. The computational information is not displayed in the child window (950 or 955).

The set of subprograms Error (100) identifies the type of error and launches an alert window with the corresponding message. In block Error (100), the previous value of the invalid option can be restored or the new value can be set by passing control to window Dialog (800). After correcting the invalid options in block Error (100), the control is passed to the set of subprograms Surface (100) and the new computational information is displayed in the active area of the working child window (950 or 955). Depending on the choice of option Console or Mouse (810) in the dialog part (50) of VAM (10), the control is passed to the corresponding block in the mathematical part (100) of VAM (10). In both cases, the local flags in blocks Console (100) and Mouse (100) are reset according to the new working information. These two blocks are interconnected. They are capable of performing the qualitative (block Console), quantitative and comparative (block Mouse) analysis of the computational data. The user can switch between blocks Console and Mouse within the mathematical part (100) of VAM (10).

Block Console (100) allows the user to shift the computational surfaces in the active area of the window, to rotate the surfaces around the coordinate axes, to rescale the surfaces displaying their zoomed fragments on the monitor. In block Console (100), the user can also change the size of the active area of the child windows and choose to display either three-dimensional or two-dimensional representations of the computational surfaces. This functional variety of block Console (100) is required for a quick qualitative analysis of the complex surfaces. If the qualitative analysis is not sufficient, the user can activate block Mouse (100).

In this set of subprograms, Mouse, the user can select any grid point in the computational surface by a mouse click. Then, the numerical values of the function and its coordinates in this grid point and the projections of the vectors connecting the grid points (not necessarily belonging to the same plot) are displayed. A simultaneous analysis of the computational information stored in stack at different iteration steps allows finding the speed at which the function changes at any grid point in different points in the phase space of system parameters.

Thus, the information collected in blocks Console and Mouse (100) allows the user to identify how to change the system parameters in order to reach the optimal solution of the computational problem connected to VAM (10). Any change made in these blocks modifies the information displayed in the active area of the child window. It is therefore necessary to periodically activate the sets of subprograms Environment and Surface while working with blocks Console and Mouse (100). After updating the child window VAM (10) returns control to the block that originally called block Console or Mouse (100). Upon right-mouse click (block Mouse (100)) or pushing Esc button (block Console (100)) VAM (10) passes control to the auxiliary block Flip-Flop (400). This block checks for a possible change of the working window in the mathematical part (100) of VAM (10). If the mode (810) of operation of VAM (10) has been changed in window Dialog (800), the global flag Mode (FM) (450) is reset and dialog block Remind Window (500) is activated in block Flip-Flop (400).

A popup window (965) appears asking to confirm the change of the mode of operation of VAM (10). Upon pressing button No (600), the control is passed to block Distributor (300), all the global flags are restored and one of the blocks of the dialog part (50) of VAM (10) is activated. Otherwise, VAM (10) switches to the passive mode of operation. The control is passed to block Parameters (550). This block sends the arrays of the new system parameters and information about the new calculation mode to the computational program (20). If button Exit is pressed in window Dialog (50), block Stop (700) is activated.

### Use of the VAM in a Demonstration Model for Field Effect Transistor

The Field Effect Transistor (“FET”) operates in two different regimes. At the gate bias (U_{G}) smaller than the FET threshold voltage (U_{T}) the source and drain contacts are separated by a potential barrier and the current between them is very low. An increase in the gate bias decreases the potential barrier height, resulting in an exponential increase in source-drain current. Above the threshold (U_{G}>U_{T}), electrons in the semiconductor are attracted to the gate creating a narrow channel (900) of length L at the interface between semiconductor and gate insulator that connects the source (905) and drain (910). The channel (900) and the gate (915) form the two plates of a capacitor separated by the gate insulator.

Let us demonstrate the advantages of VAM (10) through solving the shallow water equations describing the dynamics of the electron plasma in the channel (900) of the field effect transistor (FET). Plasma waves are oscillations of electron density in time and space. The properties of plasma waves depend on the electron density and on the dimensions and geometry of the electronic device. For the three-dimensional electron gas in a bulk semiconductor, the frequency of plasma oscillations (ω) is nearly independent of the wavelength (λ). For the two-dimensional electron gas in the channel (900) of a field effect transistors (FET), the plasma waves have a linear dispersion (ω=2πsλ) similar to that of sound waves or electromagnetic radiation. The plasma wave velocity (s) is proportional to the square root of the surface electron density (Nₛ) and can be easily tuned by the gate bias (U_{G}).

The surface capacitance is given by C=ε/d, where ε is the dielectric permittivity and d is the thickness of the gate insulator. Assuming the gradual channel approximation, the surface electron density in the FET channel is given by:

$$N ( x , t ) = \frac{CU ( x , t )}{e} , \qquad ( 1 )$$

where U(x,t)=U_{G}−U_{C}(x,t)−U_{T} is the drive voltage, U_{C}(x,t) is the channel voltage, x is the coordinate along the FET channel (900), and t is the time. The gradual channel approximation is valid when the characteristic length on which U(x,t) changes is much larger than the thickness of the gate insulator d (920).

The mean free path for electron-electron scattering (λₑₑ) in the FET channel is usually much smaller than the electron mean free path for collisions with impurities and phonons (l) as well as the channel length (L). Under this condition, the electrons behave like a fluid instead of a gas. The electron behavior is described by equations analogous to the hydrodynamic equations for shallow water:

$$\begin{matrix}\frac{\partial U ( x , t )}{\partial t} + \frac{\partial U ( x , t ) V ( x , t )}{\partial x} = 0 , & ( 2 ) \\ \frac{\partial V ( x , t )}{\partial t} + V \frac{\partial V ( x , t )}{\partial x} = - \frac{e}{m} \frac{\partial U ( x , t )}{\partial x} - \frac{V}{{τ}_{p}} + \frac{K}{{U}_{0}} \frac{{\partial }^{2} V ( x , t )}{\partial {x}^{2}} , & ( 3 )\end{matrix}$$

with the boundary conditions

$$U ( x , t ) {\vert}_{x = 0} = {U}_{0} , K \frac{\partial V ( x , t )}{\partial x} {\vert}_{x = 0} = 0 , \\ U ( x , t ) V ( x , t ) {\vert}_{x = L} = \frac{{J}_{0}}{C} , \qquad ( 4 )$$

where U(x,t) is the drive voltage, V(x,t) is the electron velocity, J(x,t)=CU(x,t)V(x,t) is the electron current, e is the elementary charge, m is the electron effective mass, τᵣ, is the momentum relaxation time due to electron scattering by phonons and impurities, K is the viscosity of the electron fluid related to electron-electron scattering, U₀ is a fixed drive voltage at the source (x=0), J₀ is a fixed current at the drain (x=L). Equation (2) is the continuity equation in the gradual channel approximation. Equation (3) is analogous to the Navier-Stokes equation, where U(x,t) corresponds to the shallow water level and V(x,t) to the water flow velocity.

The hydrodynamic equations (2)-(3) and the boundary conditions (4) can be written in dimensionless variables x=x/L and t=t/τ as follows:

$$\begin{matrix}\frac{\partial n ( x , t )}{\partial t} + \frac{\partial n ( x , t ) v ( x , t )}{\partial x} = 0 , & ( 5 ) \\ \frac{\partial v ( x , t )}{\partial t} + v ( x , t ) \frac{\partial v ( x , t )}{\partial x} = - \frac{\partial n ( x , t )}{\partial x} - γ v ( x , t ) + κ \frac{{\partial }^{2} v ( x , t )}{\partial {x}^{2}} , & ( 6 ) \\ n ( x , t ) {\vert}_{x = 0} = 1 , κ \frac{\partial V ( x , t )}{\partial x} {\vert}_{x = 0} = 0 , \\ n ( x , t ) v ( x , t ) {\vert}_{x = 1} = M , & ( 7 )\end{matrix}$$

where n(x,t)=N(x,t)Nₛ is the dimensionless surface density, v(x,t)=V(x,t)/s is the dimensionless velocity, j(x,t)=n(x,t)v(x,t) is the dimensionless flux, Nₛ=CU₀/e is the surface density, s=(eU₀/m)^{1/2} is the plasma wave velocity, M=J₀/(CU₀s) plays a role of the Mach number, γ=τ/τₚ is the dimensionless friction coefficient, κ=K/(LU₀s) is the dimensionless viscosity coefficient, and τ=L/s is the dimensionless time scale. In what follows we neglect the viscosity (κ=0).

At zero source-drain bias, the steady-state solution to equations (5) and (6) is given by n(x,t)=1 and v(x,t)=M. Let us apply a small perturbation to the steady-state solution:

n(x, t)=1+δn(x, t)=1+δn(x)exp(−iωt),

v(x, t)=M+δv(x, t)=M+δv(x)exp(−iωt), (8)

where the dimensionless frequency (ω) has both real and imaginary parts:

ω=ω″+iω″. (9)

In the absence of friction (γ=0), we substitute perturbation (8) into equations (5) and (6), linearize them with respect to δn(x) and δv(x), and use boundary conditions (7) to obtain the values of ω′ and ω″:

$${ω}^{′} = \frac{\vert 1 - {M}^{2} \vert}{2} π k , \\ {ω}^{″} = \frac{1 - {M}^{2}}{2} ln \vert \frac{1 + M}{1 - M} \vert , \qquad ( 10 )$$

where k is an odd integer for M<1 and an even integer for M>1. In the case of finite friction (γ>0) and in the limit of small Mach number (M<<1), we find:

$${ω}^{″} \approx - \frac{γ}{2} + M . \qquad ( 11 )$$

A positive imaginary part of the dimensionless frequency ω″>0 implies instability of perturbation (8). For ω″<0 the fluctuations of surface density δn(x,t) and velocity δv(x,t) are damping. The critical dimensionless friction

γ_{cr}≈2M (12)

divides the phase diagram (M,γ) into two areas, as shown in FIG. 7. On the left hand-side of γ_{cr} (925) the steady-state solution exists. On the right hand-side of γ_{cr} (930) the surface density and velocity increase exponentially. The numerical solution of equations (5)-(6) shows that this exponential rise leads to formation of shock waves in the FET channel. Equation (12) gives an asymptote to the phase line separating the two areas in the phase diagram (M,γ).

Another asymptote in phase space (M,γ) can be derived by solving the following stationary equations derived from (5)-(7):

$$\frac{d n ( x ) v ( x )}{d x} = 0 , \\ \frac{d}{d x} ( \frac{{v}^{2} ( x )}{2} + n ( x ) ) + γ v ( x ) = 0 , \\ n ( x ) {\vert}_{x = 0} = 1 , \\ n ( x ) v ( x ) {\vert}_{x = 1} = M . \qquad ( 13 )$$

Upon substituting v(x)=M/n(x) to the second equation of (13) and integrating it over x from 0 to 1, we obtain the cubic equation for the stationary surface density at the drain n(1):

n³(1)−(1+2M²−2Mγ)n(1)+2M²=0. (14)

This equation has no physical solution (935) if the dimensionless friction γ exceeds the choking threshold:

$${γ}_{ch} = \frac{1}{2 M} + M - \frac{3}{2} {M}^{1 / 3} . \qquad ( 15 )$$

Equation (15) gives the second asymptote to the phase line in the phase diagram (M,γ) shown in FIG. 7.

The Visual Analysis Module solves the shallow water hydrodynamic equations equations (5) to (7) using the Lax-Wendroff scheme. The equations describe the electron plasma in the channel of a FET. The dimensionless Mach number M, friction γ, and viscosity κ are parameters of the equations. For simplicity, we set κ=0, so that the phase space of system parameters becomes two-dimensional (M,γ). The starting point in the phase space (M₀,γ₀) is chosen in the area of shock wave generation (area A in FIG. 7). The dimensionless surface density n(x,t) and velocity v(x,t) of electrons are variables of the equations, where x is the dimensionless coordinate along the FET channel and t is the dimensionless time. The spatial and time steps in the Lax-Wendroff scheme are set to Δx=0.01 and Δt=0.005. The space-time evolution of n(x,t) and v(x,t) is shown in the child windows (950, 955) of the visual analysis module (10). The distribution of electrons across the FET channel is modeled by multiplying n(x,t) and v(x,t) by the Gaussian function exp(−y²), where y is the dimensionless coordinate across the FET channel.

When the program starts it initializes the two-level system. In the main window of the program, one can see two child windows (950, 955), a zero window (960) and an input window (750). The input window (750) plays the role of a switch for the two-level system. It also displays the initial values of system parameters M₀ and γ₀ (760) in percent (M₀=40 implies M₀=0.4, FIG. 2). The bottom part of the input window contains the control buttons (770). The top three control buttons (770) switch the two-level system by activating the visual analysis module (10). The “Run” button (770) activates the computational (20) code switching the visual analysis module to its passive state. The “Exit” button (770) terminates the program. Since all the initial settings are set in advance, one needs to press the “Run” button.

The computational code passes two arrays to the visual analysis module on every 20^{th} (830) iteration (see FIG. 3), the dimensionless surface density n(xᵢ, yⱼ, tₖ) and velocity v(xᵢ, yⱼ, tₖ). The surface density is displayed in the right child window (950). The velocity (955) is not displayed, since the left child window is in its passive state (the option “Passive” is selected in the “Window” (820) block of the “Dialog” window (800)). The transferred data n(xᵢ, yⱼ, tₖ) and v(xᵢ, yⱼ, tₖ) is accumulated in the visual analysis module (10) for further analysis. The right child window can be maximized to monitor the dynamics of electron distribution in real time at the starting point in the phase space (M₀,γ₀). The amplitude of plasma oscillations gradually increases, and the energy is transferred from the first to the zeroth harmonics. After four or five thousand iterations, the shock wave with constant amplitude is generated in the FET channel as the system reaches equilibrium. The amplitude of the shock wave depends on the initial values of system parameters M₀ and γ₀.

To move the system to a new point in the phase space (M,γ), one needs to switch the visual analysis module (10) to its active state by clicking on the zero window (960). The zero window (960) is accessible from the “Windows” menu (970) of the visual analysis module (10). The computational code (20) then switches to its passive state. Left-click on the zero window (960) opens the “Dialog” window (800) of the first child window (950). The “Dialog” window (800) contains all the main blocks of the mathematical unit (100) of the visual analysis module (10). At the bottom of the “Dialog” window (800), four control buttons (805) “OK,” “Exit,” “Option,” and “Choice” are located. The control button “Choice” opens the “Choice” window (870) where one can change the system parameters M and γ (see FIG. 5).

The system parameters M and γ are passed to the computational code (20) from the visual analysis module (10) as variables of integer type. The percent values of M and γ are displayed in the first two edit boxes of the “Choice” window (880). The values in the first two edit boxes vary in the range from 0 to 95 and from 0 to 70, respectively. This corresponds to the Mach number M=0 . . . 0.95 and friction γ=0 . . . 0.7. The physical solution does not exist in the chocking area (935) (see FIG. 7), so the computational code (20) changes the incorrect values of M and γ obtained from the visual analysis module (10) to the closest correct values. To change the system parameters M and γ, one needs to enter the new values in the first two edit boxes (880) and to set their status in the “Status” block (890) of the “Choice” window (870). If the status is set to “Active,” the new values of M and γ are passed to the computational code (20).

In order to continue the calculation one needs to switch to the “Dialog” window (800) of any child window (950 or 955) of the visual analysis module (10). To switch to the “Dialog” window (800) from the “Choice” window (870), press the control button “Dialog” (875) at the bottom of the “Choice” window (870). In the “Dialog” window (800), select the mode of the calculation in the “Next Mode” block (810) and press the control button “OK” (805) to pass control to the computational code (20). The modes “Proceed” and “Rerun” in the “Next Mode” block (810) imply that the calculation continues from the last iteration or restarts from the first iteration with the new system parameters M and y, respectively. Upon pressing the “OK” button (805), the confirmation window “Remind” (965) appears on the screen (30). Choosing “Yes” switches the visual analysis module (10) to its passive state and activates the computational code (20) (see FIG. 8). In this way one can explore the dynamics of the system in different areas of the phase space (M,γ).

In order to close the program, switch to the “Dialog” window (800), select the “Exit” option in the “Next Mode” block (810), and press the control button “Exit.” (805) A confirmation window entitled “Remind Window” (965) appears on the screen. Pressing “Yes” shuts down the child windows and terminates VAM (10), pressing “No” returns to the “Dialog” window (800). If the visual analysis module (10) is in the passive mode of operation or in one of the modes of the mathematical unit (100), it can be closed with a “Ctrl-C” key sequence.

### SEQUENCE LISTING

(see contents of CD ROMS as set forth above)

We claim:

1. A data processing system providing a user interface and computational capability known as the Visual Analysis Module (VAM) that enables the user to achieve an analysis of specific physical processes through a systematic numerical exploration of the phase space of system parameters each said analysis being comprised of:
(a) a means for user entry of initial computational systems parameters for investigation;
(b) a passive mode of operation means, wherein VAM accumulates and visualizes the computational data in real-time;
(c) an active mode of operation means, wherein VAM allows the user to analyze the accumulated data in the mathematical block, while the execution of the computational code is paused;
(d) a results means wherein VAM displays intermediate computational results for user analysis and feedback;
(e) a means for user entry of modified system parameter values; and
(f) means to resume said passive mode of operation means, with said newly user entered modified system parameter values.
